(19) United States
(12) Patent Application Publication
(10) Pub. No.: US 2024/0303378 A1
(43) Pub. Date: Sep. 12, 2024

(54) SECURITY FOR BINARY SOFTWARE DISTRIBUTIONS

(71) Applicant: Red Hat, Inc., Raleigh, NC (US)

(72) Inventor: Michael Tsirkin, Ra'anana (IL)

(21) Appl. No.: 18/120,000

(22) Filed: Mar. 10, 2023

(51) Int. Cl. G06F 21/64; G06F 21/54

(52) U.S. Cl. CPC G06F 21/64; G06F 21/54

(57) ABSTRACT

Systems and methods for language-agnostic unit testing are generally described. In various examples, first data including first source code written in a first programming language may be received. Configuration data configured to execute language-agnostic unit testing may be loaded. Input data may be determined from the first data based on a first input defined by the configuration data for a first unit test. A first driver written in the first programming language may be determined from the configuration data. The first driver may include computer-executable instructions configured to execute the first unit test. First output data may be generated by executing the first computer-executable instructions to perform the first unit test on the first input data.

### BACKGROUND

Source code typically refers to programming statements (e.g., instructions) and logic often generated in a text editor or development environment by a programmer. Source code is compiled by a compiler to generate object code. Object code is machine-readable code generated by the compiler for source code. Object code is also referred to as binary code as it may include machine instructions expressed with binary values.

### SUMMARY

The present disclosure provides a new and innovative system, methods and apparatus for improved security for binary software distributions. In an example, a method may include identifying first source code. In some examples, the method may further include generating a first binary package for the first source code. The first binary package may include at least one of a first signature or a first digest for the first source code. In various examples, the first binary package may be sent to a first recipient computing device as at least some portion of a binary software distribution.

In another example, a system may include at least one processor and non-transitory computer-readable memory. The non-transitory computer-readable memory may store instructions that, when executed by the at least one processor are configured to identify first source code. In various examples, the non-transitory computer-readable memory may store further instructions that, when executed by the at least one processor, are further configured to generate a first binary package for the first source code. In some examples, the first binary package may include at least one of a first signature or a first digest of the first source code. In various other cases, the non-transitory computer-readable memory may store further instructions that, when executed by the at least one processor, are further configured to send the first binary package to a first recipient computing device as at least some portion of a binary software distribution.

In yet another example, a non-transitory computer-readable memory is described. The non-transitory computer-readable memory may store instructions that, when executed by at least one processor, are effective to perform a method include receiving, from a first software distributor computing device, first source code. In some examples, the method may include generating a first binary package for the first source code. In some cases, the first binary package may include at least one of a first signature or a first digest of the first source code. In various examples, the method may include sending the at least one of the first signature or the first digest to the first software distributor computing device. In some cases, the first software distributor computing device may includes the at least one of the first signature or the first digest in a binary software distribution for the first source code.

Additional features and advantages of the disclosed method and apparatus are described in, and will be apparent from, the following Detailed Description and the Figures.

### BRIEF DESCRIPTION OF THE FIGURES

FIG. 1 is a block diagram of a distributor device providing a software distribution to a recipient device, where the software distribution is audited by an audit device, according to various examples of the present disclosure.

FIG. 2 depicts an example process that may be used to provide improved security for binary software distributions, in accordance with various aspects of the present disclosure.

FIG. 3 is flowchart illustrating another example process that may provide improved security for binary software distributions, according to an example of the present disclosure.

FIG. 4 illustrates an example flow diagram for providing improved security for binary software distributions, according to various aspects of the present disclosure.

FIG. 5 is block diagram of a system effective to provide improved security for binary software distributions, according to an example of the present disclosure.

### DETAILED DESCRIPTION OF EXAMPLE EMBODIMENTS

Open source software typically offers the advantage of letting users audit the source code. However, in many instances, software distributions occur as binary distributions, wherein pre-compiled code is sent to the user. Users are unable to parse and inspect binary code the same way in which they can inspect source code and so the ability to audit the open source code is largely absent. This leaves recipients of binary software distributions in a position in which they must trust the distributors to provided signed packages of software for installation.

In many cases, source code is provided together with binary packages during software distributions. However, although a recipient can audit the source code received with the binary, there is no certain way to determine if the binary completely corresponds to the source. Furthermore, generating binary packages from the provided source code is a complex, computationally intensive process. Indeed, requiring a recipient to generate the binary packages themselves from the provided source code eliminates one of the benefits of binary software distributions (e.g., Linux distributions and other binary distributions which are typically smaller in size relative to source distributions). Accordingly, for users that do not want to go through the trouble and effort of generating their own binary packages from provided source code, one of the advantages of using open source software is lost (e.g., the ability to audit the code).

Described herein are various techniques that may be used to provide assurance that the binary package in a binary software distribution matches the provided source code. In various examples described herein, the binary package may be modified to include either a digest of the source code or a cryptographic signature for the source code. In a digest, the source code (or some portion thereof) is input into a hash function to return the digest (e.g., a code representing the input source code data). The digest (or cryptographic signature) can be included in the binary package so that the recipient can verify that the binary code matches and/or otherwise corresponds to the source code.

In various examples described herein additional layers of security may be provided for binary software distributions. For example, in addition to the vendor and/or distributor of the binary distribution signing the binary package with the source signature, the vendor/distributor may send the source code of the distribution to an audit device (e.g., an auditor system). Additionally, the vendor/distributor may send metadata and/or instructions used by the audit device to generate the binary package from the provided source code (e.g., the target build environment as the build environment may have a significant impact on the content of the final binaries). The audit device may generate a signature/digest for the source code and may independently compile the source code to generate a binary package (using the provided metadata/instructions from the vendor/distributor). The audit device may also generate a signature/digest for the binary code that it independently generated. The signatures/digests for the source code and/or the binary code generated by the audit device may be included in the binary package generated by the vendor/distributor as an added layer of authentication. The recipient of the binary package (e.g., the recipient in the software distribution) may check to see whether a required set of signatures/digests is present, and may permit installation only if the required set of signatures/digests (e.g., from both the vendor/distributor and the audit device) are present. Each distinct signature in the binary package may be associated with a specific and distinct public key. Accordingly, using the various techniques described herein, a recipient of a binary software distribution may verify that the binary package matches the provided source code without being required to generate the binaries themselves.

Generally, as referred to herein, a digest refers to a fixed length block of data generated from an input of arbitrary length (e.g., the source code or some portion of it) using a one-way hash function. A signature refers to encryption of data (e.g., the source code or the digest described above) using a private key. Signatures are verifiable through use of the corresponding public key, which may be used to decrypt the signature, recalculating a hash digest of the message (e.g., the source code), and comparing the two (e.g., the hash digests).

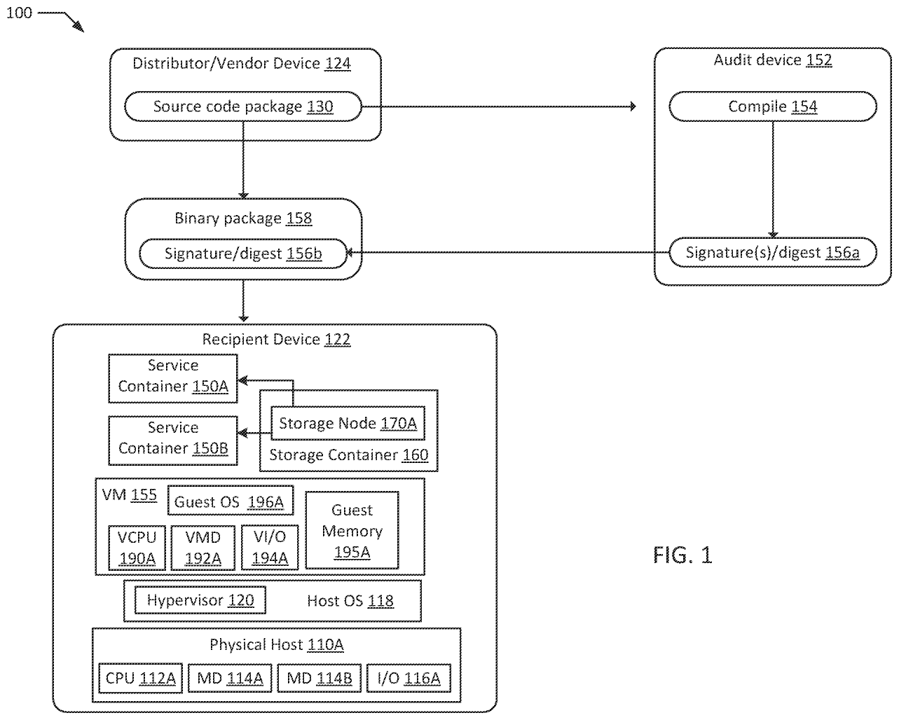

FIG. 1 is a block diagram 100 of a distributor/vendor device 124 providing a software distribution to a recipient device 122, where the software distribution (e.g., binary package 158) is audited by an audit device 152, according to various examples of the present disclosure. The audit device 152, distributor/vendor device 124, and/or recipient device 122 may be implemented using software, hardware, and/or some combination thereof. A more detailed example architecture is illustrated for the recipient device 122. It should be noted that the various components of the recipient device 122 are shown by way of illustration only. In various examples, the distributor/vendor device 124 and/or the audit device 152 may include one or more of the various components depicted as part of the recipient device 122 in FIG. 1. Accordingly, while various components in FIG. 1 are described as being part of the recipient device 122, such components could instead be part of the other devices, such as the distributor/vendor device 124 and/or the audit device 152.

In the example depicted in FIG. 1, the recipient device 122 may include one or more physical host(s), including physical host 110A. Physical host 110A may in turn include one or more physical processor(s) (e.g., CPU 112A) communicatively coupled to one or more memory device(s) (e.g., MDs 114A-B) and one or more input/output device(s) (e.g., I/O 116A). As used herein, physical processor or processors 112A refer to devices capable of executing instructions encoding arithmetic, logical, and/or I/O operations. In one illustrative example, a processor may follow Von Neumann architectural model and may include an arithmetic logic unit (ALU), a control unit, and a plurality of registers. In an example, a processor may be a single core processor which is typically capable of executing one instruction at a time (or process a single pipeline of instructions), or a multi-core processor which may simultaneously execute multiple instructions and/or threads. In another example, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (“CPU”).

As discussed herein, memory devices 114A-B refer to volatile or non-volatile memory devices, such as RAM, ROM, EEPROM, or any other device capable of storing data. In an example, memory devices 114A may be persistent storage devices such as hard drive disks (“HDD”), solid state drives (“SSD”), and/or persistent memory (e.g., Non-Volatile Dual In-line Memory Module (“NVDIMM”)). Memory devices 114A-B may additionally include replication of data to prevent against data loss due to a failure in any one device. This replication may be implemented through, for example, a redundant array of independent disks (“RAID”) setup. RAID arrays may be designed to increase performance, to provide live data backup, or a combination of both. As discussed herein, I/O device(s) 116A refer to devices capable of providing an interface between one or more processor pins and an external device, the operation of which is based on the processor inputting and/or outputting binary data. CPU(s) 112A may be interconnected using a variety of techniques, ranging from a point-to-point processor interconnect, to a system area network, such as an Ethernet-based network. Local connections within physical hosts 110A, including the connections between processors 112A and memory devices 114A-B and between processors 112A and I/O device 116A may be provided by one or more local buses of suitable architecture, for example, peripheral component interconnect (PCI).

In an example, physical host 110A may run one or more isolated guests, for example, VM 155, which may in turn host additional virtual environments (e.g., VMs and/or containers). In an example, a container (e.g., storage container 160, service containers 150A-B) may be an isolated guest using any form of operating system level virtualization, for example, Red Hat® OpenShift®, Docker® containers, chroot, Linux®-VServer, FreeBSD® Jails, HP-UX® Containers (SRP), VMware ThinApp®, etc. Storage container 160 and/or service containers 150A-B may run directly on a host operating system (e.g., host OS 118) or run within another layer of virtualization, for example, in a virtual machine (e.g., VM 155). In an example, containers that perform a unified function may be grouped together in a container cluster that may be deployed together (e.g., in a Kubernetes® pod). In an example, a given service may require the deployment of multiple VMs, containers and/or pods in multiple physical locations. In an example, VM 155 may be a VM executing on physical host 110A.

Recipient device 122 may run one or more VMs (e.g., VMs 155), by executing a software layer (e.g., hypervisor 120) above the hardware and below the VM 155, as schematically shown in FIG. 1. In an example, the hypervisor 120 may be a component of respective host operating system 118 executed on physical host 110A, for example, implemented as a kernel based virtual machine function of host operating system 118. In another example, the hypervisor 120 may be provided by an application running on host operating system 118A. In an example, hypervisor 120 may run directly on physical host 110A without an operating system beneath hypervisor 120. Hypervisor 120 may virtualize the physical layer, including processors, memory, and I/O devices, and present this virtualization to VM 155 as devices, including virtual central processing unit (“VCPU”) 190A, virtual memory devices (“VMD”) 192A, virtual input/output (“VI/O”) device 194A, and/or guest memory 195A. In an example, another virtual guest (e.g., a VM or container) may execute directly on host OSs 118 without an intervening layer of virtualization.

In an example, a VM 155 may be a virtual machine and may execute a guest operating system 196A which may utilize the underlying VCPU 190A, VMD 192A, and VI/O 194A. Processor virtualization may be implemented by the hypervisor 120 scheduling time slots on physical CPUs 112A such that from the guest operating system's perspective those time slots are scheduled on a virtual processor 190A. VM 155 may run on any type of dependent, independent, compatible, and/or incompatible applications on the underlying hardware and host operating system 118. The hypervisor 120 may manage memory for the host operating system 118 as well as memory allocated to the VM 155 and guest operating system 196A such as guest memory 195A provided to guest OS 196A. In an example, storage container 160 and/or service containers 150A, 150B are similarly implemented.

In an example, in addition to distributed storage provided by storage container 160, a storage controller may additionally manage storage in dedicated storage nodes (e.g., NAS, SAN, etc.). In an example, a storage controller may deploy storage in large logical units with preconfigured performance characteristics (e.g., storage nodes 170A). In an example, access to a given storage node (e.g., storage node 170A) may be controlled on an account and/or tenant level. In an example, a service container (e.g., service containers 150A-B) may require persistent storage for application data, and may request persistent storage with a persistent storage claim to an orchestrator (not shown in FIG. 1). In the example, a storage controller may allocate storage to service containers 150A-B through a storage node (e.g., storage nodes 170A) in the form of a persistent storage volume. In an example, a persistent storage volume for service containers 150A-B may be allocated a portion of the storage capacity and throughput capacity of a given storage node (e.g., storage nodes 170A). In various examples, the storage container 160 and/or service containers 150A-B may deploy compute resources (e.g., storage, cache, etc.) that are part of a compute service that is distributed across multiple clusters (not shown in FIG. 1).

The distributor/vendor device 124 may have a source code package 130 (e.g., open source source code for distribution). A “package”, as used herein, may refer to individual files or other compute resources are grouped together as a software collection that provides certain functionality as part of a larger system. The distributor/vendor device 124 may compile the source code package 130 to generate binary package 158. In various examples, the binary package 158 may be a Red Hat® Package Manager (RPM) package, a Microsoft® Software Installer (MSI) package, an iOS® package app (IPA) package, an Android® Package Kit (APK) package, a Debian package (DEB) for a Linux package, or the like.

In addition, in some examples, the distributor/vendor device 124 may generate a signature or digest of the source code package (e.g., signature/digest 156b) which may be incorporated into the binary package 158. In various examples, the recipient device 122 may check that the signature digest 156b matches the source code package 130 prior to installation and/or execution of the binary package 158.

In various other examples, the distributor/vendor device 124 may send the source code package 130 to audit device 152. In various examples, the distributor/vendor device 124 may also send metadata and/or instructions that the audit device 152 may use to generate a binary package from the source code package 130. For example, the distributor/vendor device 124 may send metadata identifying a build environment for the binary package. The audit device 152 may compile (block 154) the source code package 130 according to the build environment and may generate signature(s)/digest 156a. The signature(s)/digest 156a may be signatures and/or digests generated by audit device 152 for the source code package 130 and/or the independently-generated binary package generated through the compilation at block 154. The audit device 152's signatures may be verified by the recipient device using a distinct public key that is specific to the audit device 152. In various examples, the signature(s)/digest 156a generated by the audit device 152 may be incorporated into the binary package 158 generated by the distributor/vendor device 124.

The recipient device 122 may receive the binary package 158 including the one or more signatures/digests (e.g., signature/digest 156a and/or 156b). In various examples, the recipient device 122 may programmatically check to ensure that all required signatures/digests are present prior to installation of the binary package 158. The signatures/digests may confirm that the source code package 130 (which may be provided to the recipient device 122 together with the binary package 158) matches the binary package 158. Accordingly, the recipient device 122 may independently audit the source code package 130 and may trust that the generated binary package 158 matches the source code package 130 (due to signatures/digests 156a and/or 156b).

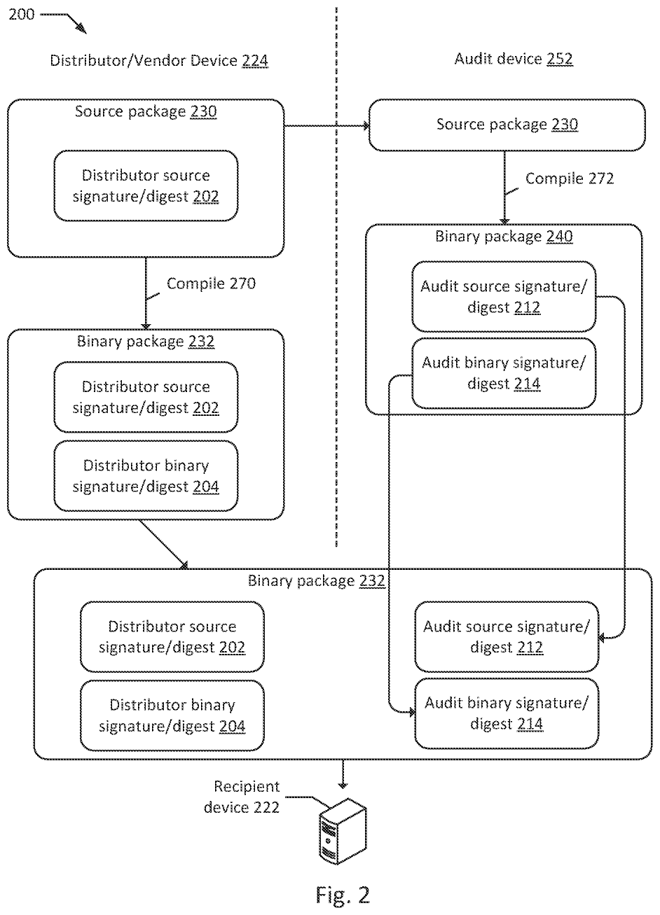

FIG. 2 depicts an example process 200 that may be used to provide improved security for binary software distributions, in accordance with various aspects of the present disclosure. In the example in FIG. 2, the distributor/vendor device 224 may generate or otherwise have source package 230 (e.g., a source code package). The distributor/vendor device 224 may provide a distributor source signature/digest 202 for the source package 230. The distributor/vendor device 224 may compile (action 270) the source package 230 to generate binary package 232. The distributor/vendor device 224 may provide the distributor source signature/digest 202 in the generated binary package 232 to indicate that the binary package 232 matches the source package 230. In some example implementations, this binary package 232 signed with the distributor source signature/digest 202 may be enough and may be provided to the recipient device 222. However, in other examples, enhanced security may be provided to the binary package 232. For example, in some examples, the distributor/vendor device 224 may also provide a distributor binary signature/digest 204 for the binary package 232.

In some examples, prior to sending the binary package 232 to the recipient device 222, the distributor/vendor device 224 may send the source package 230 to the audit device 252. The audit device 252 may be a device that is under the control of the distributor/vendor device 224, the recipient device 222, or a third party device. In some examples, as previously described, the distributor/vendor device 224 may also send metadata and/or instructions regarding the target build environment to the audit device 252 so that the audit device 252 can generate the appropriate binaries from the source package 230.

The audit device 252 may independently compile (action 272) the source package 230 to generate an independent binary package 240 (e.g., using the target build environment metadata). The audit device 252 may generate a signature/digest for the source package (e.g., audit source signature/digest 212) and/or a signature/digest for the independently-generated binary package 240 (e.g., audit binary signature/digest 214). The audit device 252's signatures/digests (e.g., audit source signature/digest 212 and/or audit binary signature/digest 214) may be incorporated into the binary package 232 generated by the distributor/vendor device 224 prior to sending the binary package 232 to the recipient device 222. Additionally, although not shown in FIG. 2, the source package 230 may be sent to the recipient device 222. The recipient device 222 may thereafter audit the source package 230 and may ensure that the proper signatures/digests are included in the binary package 232. For example, the recipient device 222 may use a public key specific to the distributor/vendor to determine a digest of the distributor source signature/digest 202. The recipient device 222 may compare this digest to an independently-generated digest for the provided source package 230. A similar operation may optionally be performed for the audit source signature/digest (e.g., using a public key specific to the audit device 252). Upon verifying that all required signatures are present and that the binary package 232 matches the source package 230, the recipient device 222 may install the binary package 232.

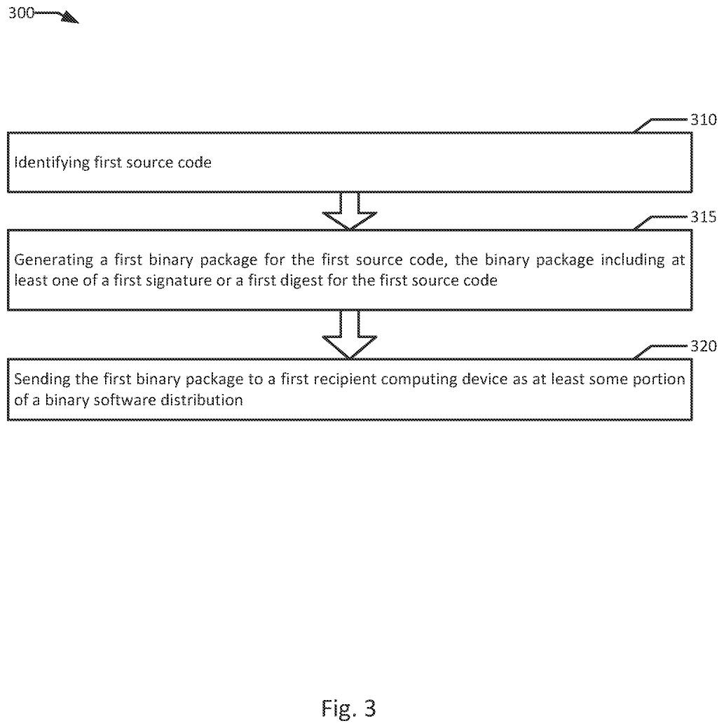

FIG. 3 is flowchart illustrating an example process 300 that may provide improved security for binary software distributions, according to an example of the present disclosure. Although the example process 300 is described with reference to the flowchart illustrated in FIG. 3, it will be appreciated that many other methods of performing the acts associated with the process 300 may be used. For example, the order of some of the blocks may be changed, certain blocks may be combined with other blocks, blocks may be repeated, and some of the blocks described may be optional. The process 300 may be performed by processing logic that may comprise hardware (circuitry, dedicated logic, etc.), software, or a combination of both. In some examples, the actions described in the blocks of the process 300 may represent a series of instructions comprising computer-readable machine code executable by one or more processing units of one or more computing devices. In various examples, the computer-readable machine codes may be comprised of instructions selected from a native instruction set of and/or an operating system (or systems) of the one or more computing devices.

In various examples, the process 300 may include identifying first source code at action 310. The first source code may be a software distribution package that includes source code (e.g., source package 230 of FIG. 2). The identification of the first source code may be performed by a vendor/distributor device (e.g., distributor/vendor device 224), by an audit device (e.g., audit device 252), or both.

The process 300 may continue at action 315, at which a first binary package for the first source code may be generated. The first binary package may include at least one of a first signature or a first digest for the first source code. The first binary package for the first source code can be generated by the vendor/distributor, the audit device, and/or independently by both. The first signature and/or first digest may also be generated by the vendor/distributor, the audit device, or both. Essentially, by generating the signature and/or digest for the source code and incorporating this signature and/or digest in the binary package, the generating entity confirms that the generated binaries match the relevant source code (which may also be provided during a software distribution).

The process 300 may continue at action 320, at which the first binary package may be sent to a first recipient computing device as at least some portion of a binary software distribution. For example, the first binary package including the first signature and/or the first digest may be sent to the first recipient computing device (e.g., a recipient of the software distribution). In various examples, the source code used to generate the first binary package (e.g., the source package) may also be provided. The first recipient may use a public key that is specific to the particular signature to decode the signature and generate a digest and may confirm that the digest matches the expected digest (e.g., the digest independently generated by the recipient from the source code). For example, a first public key specific to the vendor and/or distributor may be used for the vendor signature, while an audit public key may be used for the audit device signature.

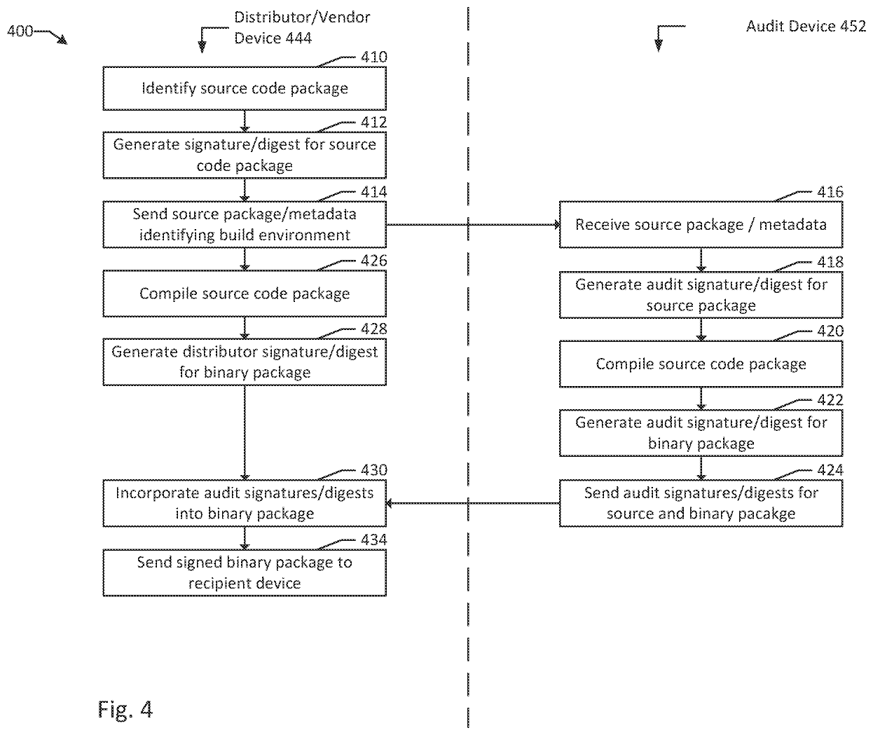

FIG. 4 illustrates an example flow diagram for providing improved security for binary software distributions, according to various aspects of the present disclosure. Although the examples below are described with reference to the flow diagram illustrated in FIG. 4, many other methods of performing the acts associated with FIG. 4 may be used. For example, the order of some of the blocks may be changed, certain blocks may be combined with other blocks, and some of the blocks described are optional. The methods may be performed by processing logic that may comprise hardware (circuitry, dedicated logic, etc.), software, or a combination of both.

In illustrated example 400, a distributor/vendor device 444 (or some other computing device involved in a software distribution) may identify a source code package (block 410). The source code package may be software that is to be distributed as part of a software distribution. In various examples, the distributor/vendor device 444 may generate a signature/digest (or other cryptographic information) for the source code package (block 412). For example, a digest may be generated for the source code package using a one-way cryptographic hash function. The digest may be encrypted using a private key of the distributor/vendor device 444 to generate a signature which may be included with the source code package. The distributor/vendor device 444 may send the source package and/or metadata identifying the target build environment for the software distribution to an audit device 452 (block 414).

The audit device 452 may receive the source package/metadata (block 416) from the distributor/vendor device 444. The audit device 452 may generate its own, independent audit signature/digest (or other cryptographic information) for the source package (block 418). Note that the audit device 452 may use its own private key when generating a signature. The audit device 452 may compile the source package using the build environment metadata (block 420) to generate a binary package (independent of the binary package generated by the distributor/vendor device 444). The audit device 452 may independently generate an audit signature/digest for the binary package (block 422). The audit device 452 may send the audit signatures/digests for source and binary package (block 424) to the distributor/vendor device 444.

At block 426, the distributor/vendor device 444 may compile the source code package (e.g., the source code package identified at block 410) to generate an independent instance of the binary package. The distributor/vendor device 444 may generate a distributor signature and/or digest for the binary package (block 428) and may include this cryptographic information in the binary package. At block 430, the distributor/vendor device 444 may incorporate the audit signatures/digests into the binary package that was generated by the distributor/vendor device 444 (block 430). Accordingly, after block 430, the binary package may include both the distributor signature/digest and the audit signatures/digests (e.g., for both source code and the independently generated binaries).

The distributor/vendor device 444 may send the signed binary package to a recipient device (block 434). The signed binary package may include signatures from the distributor/vendor device 444 and/or from one or more audit devices (including audit device 452). The signatures may be decrypted using public keys (which may be specific to the service providing the signature) to generate respective digests. The digests may be used to verify that the source code provided as part of the software distribution matches the binary distribution. In this way, the recipient can audit the source code (if desired) and can verify that the provided binary matches the audited source code prior to installation. Multiple assurances may be provided to the recipient device in the form of signatures/digests from different entities (e.g., distributor/vendor device 444, audit device 452, and/or other audit systems providing similar functionality to audit device 452).

In another alternate implementation, the cryptographic information (e.g., digests and/or signatures) for the source code and the binary code (whether generated by the vendor, distributor, audit system, etc.) may be uploaded on a secure website (e.g., a website protected with encryption), together with the source code, with the website having a certificate chain of trust. The software distribution recipient can then access the website to determine if the received binary package matches the source code.

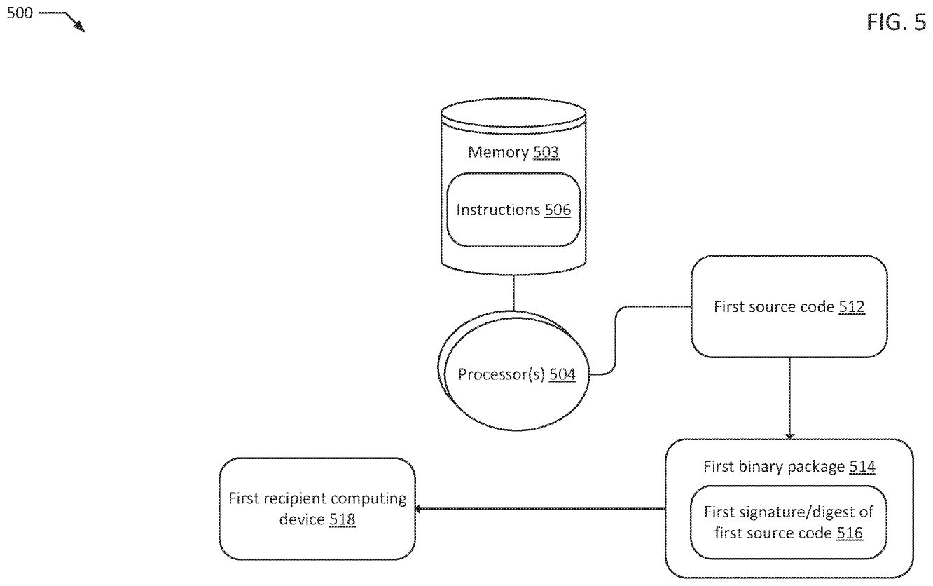

FIG. 5 is block diagram of a system 500 effective to provide improved security for binary software distributions, according to an example of the present disclosure. System 500 may comprise at least one processor 504 and non-transitory computer-readable memory 503. The memory 503 may store instructions 506. The instructions 506 may be executed by the at least one processor 504 to perform various techniques described herein related to improved security for binary software distributions.

For example, the at least one processor 504 may receive first source code 512. The first source code 512 may be a software distribution package that includes source code (e.g., source package 230 of FIG. 2). The identification of the first source code may be performed by a vendor/distributor device (e.g., distributor/vendor device 224), by an audit device (e.g., audit device 252), or both.

The at least one processor 504 may generate a first binary package 514 for the first source code 512. For example, the at least one processor 504 may compile the first source code 512 to generate the first binary package 514. In addition, the at least one processor 504 may generate a first signature/digest of the first source code 516. The first binary package 514 for the first source code 512 can be generated by the vendor/distributor, the audit device, and/or independently by both. The first signature and/or first digest of the first source code 516 may also be generated by the vendor/distributor, the audit device, or both. Essentially, by generating the signature and/or digest for the source code and incorporating this signature and/or digest in the first binary package 514, the generating entity provides a means for a recipient of the first binary package 514 and/or first source code 512 to confirm that the first binary package 514 matches the first source code 512 (which may also be provided during a software distribution). The first binary package 514 including the first signature/digest of first source code 516 may be sent to the first recipient computing device 518 as part of a binary software distribution. The first recipient computing device 518 may use a public key that is specific to the particular signature to decode the signature and generate a digest and may confirm that the digest matches the expected digest (e.g., the digest independently generated by the recipient from the first source code 512). For example, a first public key specific to the vendor and/or distributor may be used for the vendor and/or distributor signature, while an audit public key may be used for the audit device signature.

It will be appreciated that all of the disclosed methods and procedures described herein can be implemented using one or more computer programs or components. These components may be provided as a series of computer instructions on any conventional computer readable medium or machine readable medium, including volatile or non-volatile memory, such as RAM, ROM, flash memory, magnetic or optical disks, optical memory, or other storage media. The instructions may be provided as software or firmware, and/or may be implemented in whole or in part in hardware components such as ASICs, FPGAs, DSPs or any other similar devices. The instructions may be executed by one or more processors, which when executing the series of computer instructions, performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
identifying first source code;
generating a first binary package for the first source code, wherein the first binary package comprises at least one of a first signature or a first digest for the first source code; and
sending the first binary package to a first recipient computing device as at least some portion of a binary software distribution.

2. The method of claim 1, wherein the first signature or the first digest indicates that the first binary package corresponds to the first source code.

3. The method of claim 1, further comprising:
sending the first source code to an auditor system, wherein the auditor system is configured to generate a second binary package for the first source code;
receiving, from the auditor system, a second signature for the second binary package; and
incorporating the second signature in the first binary package prior to the sending the first binary package to the first recipient.

4. The method of claim 3, further comprising sending metadata describing a build environment to the auditor system, wherein the metadata is used during the generation of the second binary package.

5. The method of claim 1, further comprising:
determining a first auditor system and a second auditor system specified by the first recipient computing device;
sending the first source code to the first auditor system;
receiving, from the first auditor system, a second signature for a second binary package generated by the first auditor system from the first source code;
sending the first source code to the second auditor system;
receiving, from the second auditor system, a third signature for a third binary package generated by the second auditor system from the first source code; and
incorporating the second signature and the third signature in the first binary package prior to sending the first binary package to the first recipient.

6. The method of claim 1, further comprising incorporating first cryptographic information into the first binary package, wherein the first cryptographic information is generated based at least in part on an independent generation of a second binary package for the first source code by a different system than a system generating the first binary package.

7. The method of claim 1, further comprising generating a first source package comprising the first source code to the first recipient computing device, wherein the at least one of the first signature or the first digest indicates that the first source package matches the first binary package.

8. The method of claim 1, wherein the first binary package is an RPM package, an MSI package, a DEB package, an IPA package, or an APK package.

9. A system comprising:
at least one processor; and
non-transitory computer-readable memory storing instructions that, when executed by the at least one processor, are effective to:
identify first source code;
generate a first binary package for the first source code, wherein the first binary package comprises at least one of a first signature or a first digest of the first source code; and
send the first binary package to a first recipient computing device as at least some portion of a binary software distribution.

10. The system of claim 9, wherein the first signature or the first digest indicates that the first binary package corresponds to the first source code.

11. The system of claim 9, the non-transitory computer-readable memory storing further instructions that, when executed by the at least one processor, are further effective to:
send the first source code to an auditor system, wherein the auditor system is configured to generate a second binary package for the first source code;
receive, from the auditor system, a second signature for the second binary package; and
incorporate the second signature in the first binary package prior to the sending the first binary package to the first recipient.

12. The system of claim 11, the non-transitory computer-readable memory storing further instructions that, when executed by the at least one processor, are further effective to:
send metadata describing a build environment to the auditor system, wherein the metadata is used during the generation of the second binary package.

13. The system of claim 9, the non-transitory computer-readable memory storing further instructions that, when executed by the at least one processor, are further effective to:
determine a first auditor system and a second auditor system specified by the first recipient computing device;
send the first source code to the first auditor system;
receive, from the first auditor system, a second signature for a second binary package generated by the first auditor system from the first source code;
send the first source code to the second auditor system;
receive, from the second auditor system, a third signature for a third binary package generated by the second auditor system from the first source code; and
incorporate the second signature and the third signature in the first binary package prior to sending the first binary package to the first recipient.

14. The system of claim 9, the non-transitory computer-readable memory storing further instructions that, when executed by the at least one processor, are further effective to incorporate first cryptographic information into the first binary package, wherein the first cryptographic information is generated based at least in part on an independent generation of a second binary package for the first source code by a different system than a system generating the first binary package.

15. The system of claim 9, the non-transitory computer-readable memory storing further instructions that, when executed by the at least one processor, are further effective to generate a first source package comprising the first source code to the first recipient computing device, wherein the at least one of the first signature or the first digest indicates that the first source package matches the first binary package.

16. The system of claim 9, wherein the first binary package is an RPM package, an MSI package, a DEB package, an IPA package, or an APK package.

17. A method comprising:
receiving, from a first software distributor computing device, first source code;
generating a first binary package for the first source code, wherein the first binary package comprises at least one of a first signature or a first digest of the first source code; and
sending the at least one of the first signature or the first digest to the first software distributor computing device, wherein the first software distributor computing device includes the at least one of the first signature or the first digest in a binary software distribution for the first source code.

18. The method of claim 17, wherein the first signature or the first digest indicates that the first binary package corresponds to the first source code.

19. The method of claim 17, further comprising receiving first data indicating a build environment for the first binary package, wherein the generating the first binary package for the first source code is based at least in part on the first data.

20. The method of claim 17, wherein the first binary package is an RPM package, an MSI package, a DEB package, an IPA package, or an APK package.
